(19) United States
(12) Patent Application Publication
(10) Pub. No.: US 2019/0384131 A1
(43) Pub. Date: Dec. 19, 2019

(54) LIQUID CRYSTAL DISPLAY PANEL HAVING NOVEL PIXEL DESIGN

(71) Applicant: SHENZHEN CHINA STAR OPTOELECTRONICS SEMICONDUCTOR DISPLAY TECHNOLOGY CO., LTD., Shenzhen ,Guangdong (CN)

(72) Inventor: Linfeng LIU, Shenzhen, Guangdong (CN)

(73) Assignee: SHENZHEN CHINA STAR OPTOELECTRONICS SEMICOMDUCTOR DISPLAY TECHNOLOGY CO., LTD., Shenzhen , Guangdong (CN)

(21) Appl. No.: 15/748,337

(22) PCT Filed: Nov. 1, 2017
(86) PCT No.: PCT/CN2017/108899

§ 371 Date: Jan. 29, 2018

(30) Foreign Application Priority Data
Oct. 17, 2017 (CN) 201710966626.1

(51) Int. Cl. G02F 1/1362; G02F 1/1343

(52) U.S. Cl. CPC G02F 1/136286; G02F 1/1343

(57) ABSTRACT

A LCD panel having a novel pixel design is provided, including a first substrate, a second substrate, and a liquid crystal layer disposed between the two substrates; a common electrode is arranged on a side surface of the first substrate; a plurality of gate lines and data lines are disposed on the second substrate, which define a plurality of pixel units; each of the pixel units includes a main pixel electrode and a sub-pixel electrode connected to each other, and a pattern of the main pixel electrode is different from that of the sub-pixel electrode; each of the pixel units further includes a thin film transistor connected to a gate line, and the main pixel electrode and the sub-pixel electrode acquire display signals through the thin film transistors. The disclosure can improve the viewing angle, reduce the complexity of the control circuit, and improve the aperture ratio of the pixel.

### RELATED APPLICATIONS

The present application is a National Phase of International Application Number PCT/CN2017/108899, filed Nov. 1, 2017, and claims the priority of China Application No. 201710966626.1, filed Oct. 17, 2017.

### FIELD OF THE DISCLOSURE

The disclosure relates to the field of display, and in particular to a liquid crystal display panel having a novel pixel design.

### BACKGROUND

Most of the liquid crystal displays on the market are backlight type liquid crystal displays, which include a shell, a liquid crystal display panel arranged in the shell, and a backlight module arranged in the shell. The liquid crystal display panel is the main component of the liquid crystal display. However, the liquid crystal display panel itself does not emit light, and the image needs to be displayed normally by the light source provided by the backlight module.

In general, a liquid crystal display panel is formed by bonding two glass substrates, and liquid crystals are injected between the two glass substrates, and a pixel electrode and a common electrode are respectively disposed on opposite inner sides of the two glass substrates, the liquid crystal molecules are controlled to change the direction by power on or not, so as to refract the light of the backlight module to produce a picture.

In a conventional LCD, a serious color washout occurs at a large viewing angle, this situation is more evident in the vertical alignment (VA) type LCD; due to the different viewing angle, the liquid crystal molecules birefringence difference of the VA type liquid crystal display is larger, so the color washout is more serious. The prior art has improved the color washout of LCD at a large viewing angle through pixel designs that employ multi-domain displays, for example, in some examples, it is necessary to set the main pixel electrode and the sub-pixel electrode, and each zone includes a multi-domain (e.g., four domains) and the main pixel electrode and sub-pixel electrode are respectively controlled by different thin film transistors (TFT), and the main pixel electrode and sub-pixel electrode are provided by different driving voltages, so the liquid crystal of the main pixel electrode and the sub-pixel electrode produces different rotational behavior, thereby performing a mixing compensation to the Gamma value at a large viewing angle, so as to achieve the purpose of improving the color washout.

As shown in FIG. 1, a conventional liquid crystal display panel is shown, in which a pixel electrode structure arranged between two data lines 1′ is shown, which adopts a pixel design of eight-domain display. The main pixel electrode 30′ and the sub-pixel electrode 31′ are both four domains, the TFT unit 2′ and the gate line 4′ is arranged between the main pixel electrode 30 and the sub-pixel electrode 31′; it can be seen from the above that, in the existing structure, a pixel electrode usually needs at least three TFT units 2′, and the control circuit is relatively complicated, and the aperture ratio of the pixel is reduced.

### SUMMARY

A technical problem to be solved by the disclosure is to provide a liquid crystal display panel having a novel pixel design which can improve the viewing angle of display, and reduce the complexity of the pixel control circuit, and can improve the pixel aperture ratio.

To solve the technical problem, an aspect of an embodiment of the disclosure provides a liquid crystal display panel having a novel pixel design, including a first substrate and a second substrate disposed opposite to each other, and a liquid crystal layer disposed between the first substrate and the second substrate, and

a common electrode is arranged on a side surface of the first substrate;

a plurality of gate lines and a plurality of data lines are disposed on the second substrate, the plurality of gate lines and the plurality of data lines define a plurality of pixel units, each of the plurality of pixel units includes a main pixel electrode and a sub-pixel electrode connected to each other, and a pattern of the main pixel electrode is different from a pattern of the sub-pixel electrode;

each of the pixel units further includes a thin film transistor connected to the gate line, and the main pixel electrode and the sub-pixel electrode both acquire a display signal through the thin film transistor.

The main pixel electrode and the sub-pixel electrode both include a main electrode line and a branch electrode line connected to the main electrode line, and the main electrode line of the main pixel electrode is connected to the main electrode line of the sub-pixel electrode.

A ratio of a line width to a line spacing of a branch electrode line in the sub-pixel electrode is less than a ratio of a line width to a line spacing of a branch electrode line in the main pixel electrode.

The main pixel electrode and the sub-pixel electrode are arranged in parallel, and the ratio of the line width to the line spacing of the branch electrode line in the sub-pixel electrode is less than the ratio of the line width to the line spacing of the branch electrode line in the main pixel electrode.

The main pixel electrode and the sub-pixel electrode are alternately arranged with each other; the sub-pixel electrode includes a first sub-pixel electrode and a second sub-pixel electrode, and the main pixel electrode is disposed between the first sub-pixel electrode and the second sub-pixel electrode.

The main pixel electrode and the sub-pixel electrode are nested, and the sub-pixel electrode is disposed at a center of the main pixel electrode.

An included angle between the branch electrode line of the sub-pixel electrode and the branch electrode line of the sub-pixel electrode is different from an included angle between the branch electrode line of the main pixel electrode and the main pixel electrode in the same direction of the main electrode.

An included angle between the branch electrode line of the main pixel electrode and a vertical branch electrode line in the main pixel electrode is greater than or equal to 45°, and an included angle between the branch electrode line of the sub-pixel electrode and the vertical main electrode line in the sub-pixel electrode is less than 45°.

The main pixel electrode is a “ [symbol] ” shape pattern and the sub-pixel electrodes are planar or comb-shaped.

A plurality of data lines arranged in a column direction and a plurality of gate lines arranged in a row direction are arranged on the second substrate, and two adjacent data lines and two adjacent gate lines define a pixel unit; in a pixel unit, the thin film transistor includes a gate electrode, a source electrode, and a drain electrode, the gate electrode is connected to one of the plurality of the gate lines, the source electrode is connected to one of the plurality of data lines, and the drain electrode is connected to the main pixel electrode and the sub-pixel electrode.

Another aspect of an embodiment of the disclosure further provides a liquid crystal display panel having a novel pixel design, including a first substrate and a second substrate disposed opposite to each other, and a liquid crystal layer disposed between the first substrate and the second substrate, and

a common electrode is arranged on a side surface of the first substrate;

a plurality of gate lines and a plurality of data lines are disposed on the second substrate, and the plurality of gate lines and the plurality of data lines define a plurality of pixel units, each of the plurality of pixel units includes a main pixel electrode and a sub-pixel electrode connected to each other, and a pattern of the main pixel electrode is different from a pattern of the sub-pixel electrode; each of the pixel units further includes a thin film transistor connected to the gate line, and the main pixel electrode and the sub-pixel electrode both acquire a display signal through the thin film transistor;

the main pixel electrode and the sub-pixel electrode both include a main electrode line and a branch electrode line connected to the main electrode line, and the main electrode line of the main pixel electrode is connected to the main electrode line of the sub-pixel electrode.

An included angle between the branch electrode line of the sub-pixel electrode and the main electrode line of the sub-pixel electrode is different from an included angle between the branch electrode line of the main pixel electrode and the main electrode line in the same direction of the main pixel electrode.

A ratio of a line width to a line spacing of a branch electrode line in the sub-pixel electrode is different from a ratio of a line width to a line spacing of a branch electrode line in the main pixel electrode.

The main pixel electrode and the sub-pixel electrode are arranged in parallel, and the ratio of the line width to the line spacing of the branch electrode line in the sub-pixel electrode is less than the ratio of the line width to the line spacing of the branch electrode line in the main pixel electrode.

The main pixel electrode and the sub-pixel electrode are alternately arranged with each other; the sub-pixel electrode includes a first sub-pixel electrode and a second sub-pixel electrode, and the main pixel electrode is disposed between the first sub-pixel electrode and the second sub-pixel electrode.

The main pixel electrode and the sub-pixel electrode are nested, and the sub-pixel electrode is disposed at a center of the main pixel electrode.

An included angle between the branch electrode line of the sub-pixel electrode and the main electrode line of the sub-pixel electrode is different from an included angle between the branch electrode line of the main pixel electrode and the main electrode line in the same direction of the main pixel electrode.

An included angle between the branch electrode line of the main pixel electrode and a vertical branch electrode line in the main pixel electrode is greater than or equal to 45°, and an included angle between the branch electrode line of the sub-pixel electrode and a vertical main electrode line in the sub-pixel electrode is less than 45 °.

The main pixel electrode is a “ [symbol] ” shape pattern and the sub-pixel electrodes are planar or comb-shaped.

A plurality of data lines arranged in a column direction and a plurality of gate lines arranged in a row direction are arranged on the second substrate, and two adjacent data lines and two adjacent gate lines jointly define a pixel unit; in the pixel unit, the thin film transistor includes a gate electrode, a source electrode, and a drain electrode, the gate electrode is connected to one of the plurality of gate lines, the source electrode is connected to one of the plurality of data lines, and the drain electrode is connected to the main pixel electrode and t sub-pixel electrode.

The embodiment of the disclosure has the following advantageous effects:

In this embodiment of the disclosure, the pixel electrode in each pixel unit is divided into the main pixel electrode and the sub-pixel electrode, and by setting the pattern of the main pixel electrode and the pattern of the sub-pixel electrode to be different, for example, the ratio of the line width to the line spacing of the branch electrode line in the sub-pixel electrode is set to be different from the ratio of the line width to the line spacing of the branch electrode line in the main pixel electrode, or a included angle between the branch electrode line of the sub-pixel electrode and the main electrode line of the sub-pixel electrode is set to be different from an included angle between the branch electrode line of the main pixel electrode and the main electrode line in the same direction of the main pixel electrode; so that when the thin film transistor drives the pixel electrode, the potential difference between the main pixel electrode and the common electrode is different from the potential difference between the sub-pixel electrode and the common electrode; the above difference can make the deflection angle of the liquid crystal corresponding to one of the regions smaller than the deflection angle of the liquid crystal corresponding to the other region, so as to obtain a larger viewing angle of the liquid crystal display pane.

In the embodiment of the disclosure, the included angle between the branch electrode line and the vertical main electrode line in the sub-pixel electrode is set to be different from the angle between the branch electrode line and the vertical main electrode line in the main pixel electrode, the azimuth angle of the liquid crystal corresponding to a part of the pixel electrodes can be reduced, so that the viewing angle of the liquid crystal display panel can be improved;

simultaneously, in the embodiment of the disclosure, since only a thin film transistor and a gate line are needed to be used for each pixel unit, the driving circuit is simplified, and the aperture ratio of the pixel is increased.

### BRIEF DESCRIPTION OF THE DRAWINGS

In order to illustrate technical schemes of the disclosure or the prior art more clearly, the following section briefly introduces drawings used to describe the embodiments and prior art. Obviously, the drawing in the following descriptions is just some embodiments of the disclosure. The ordinary person in the related art can acquire the other drawings according to these drawings without offering creative effort.

FIG. 1 is a schematic diagram of a pixel structure in the prior art;

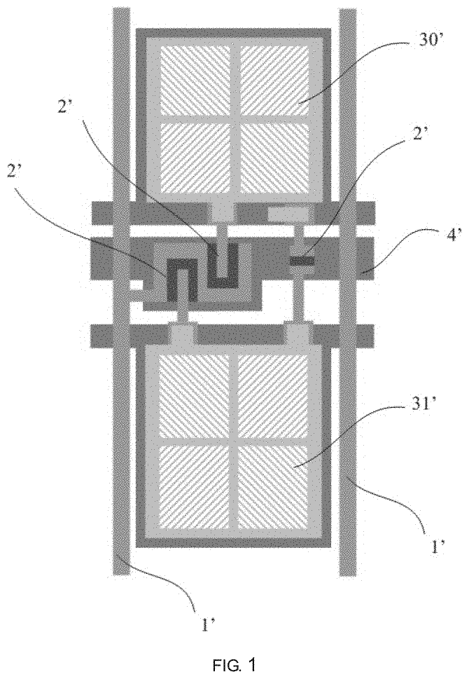

FIG. 2 is a schematic structural view of an embodiment of a liquid crystal display panel having a novel pixel design provided by the disclosure;

FIG. 3 is a schematic view of one embodiment of a pixel cell of FIG. 2;

FIG. 4 is a schematic view of another embodiment of the pixel cell of FIG. 2;

FIG. 5 is a schematic view of further another embodiment of the pixel cell of FIG. 2; and

FIG. 6 is a schematic diagram of still another embodiment of the pixel unit of FIG. 2.

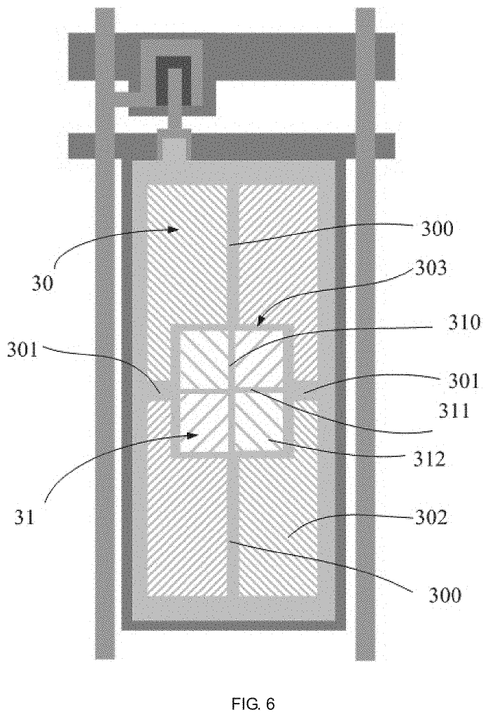

### DETAILED DESCRIPTION OF PREFERRED EMBODIMENTS

The following sections offer a clear, complete description of this disclosure in combination with the embodiments and accompanying drawings. Obviously, the embodiments described herein are only a part of, but not all of the embodiments of this disclosure. In view of the embodiments described herein, any other embodiment obtained by those of ordinary skill in the art skilled in this art without offering creative effort is included in a scope claimed by this disclosure.

Here, it should be further noted that in order to prevent the disclosure to be obscured due to unnecessary details, only apparatus structures and/or processing steps closely related to the solution according to the disclosure are shown in the accompanying drawings, while other details having little relations are omitted.

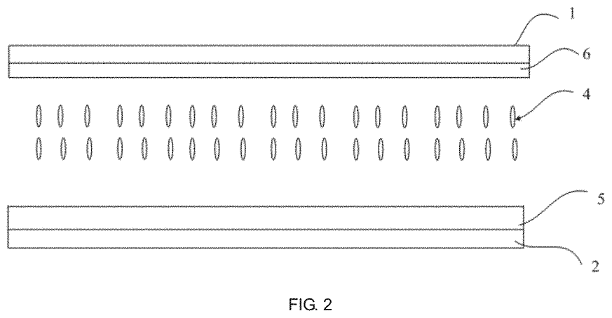

As shown in FIG. 2, which is a schematic structural view of an embodiment of a liquid crystal display panel having a novel pixel design provided by the disclosure. In this embodiment, the liquid crystal display panel at least includes: a first substrate 1, a second substrate 2 arranged opposite to the first substrate 1; and a liquid crystal layer 4 is disposed between the first substrate 1 and the second substrate 2, and:

a common electrode 6 is arranged on a side surface of the first substrate 1 opposite to the second substrate 2;

a pixel electrode layer 5 is disposed on a side surface of the second substrate 2, a plurality of gate lines and a plurality of data lines are disposed on the second substrate, and the plurality of gate lines and the plurality of data lines define a plurality of pixel units.

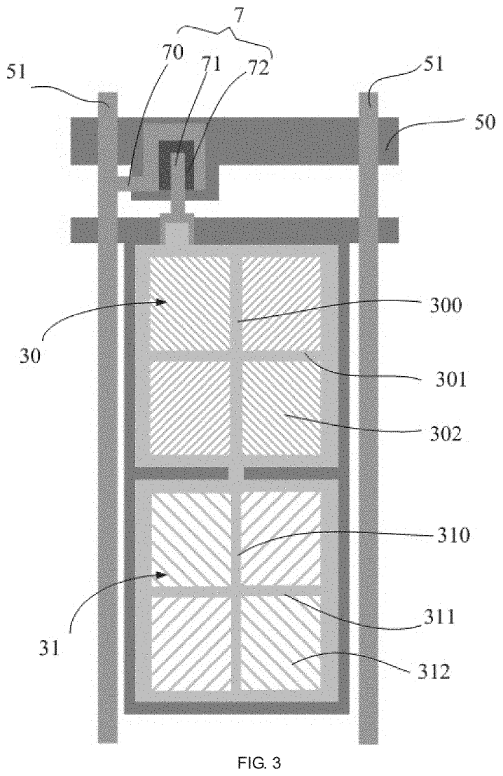

Further, please refer to FIG. 3, which shows a schematic structural view of an embodiment of a pixel unit in a liquid crystal display panel of the disclosure.

It can be understood that, a plurality of data lines 51 arranged in the column direction and a plurality of gate lines 50 arranged in the row direction are disposed on the second substrate 2, and two adjacent data lines 51 and two adjacent gate lines 50 jointly define a pixel unit. In the pixel unit, the pixel unit includes a main pixel electrode 30 and a sub-pixel electrode 31 connected to each other. The pixel unit further includes a thin film transistor (TFT) 7, and the main pixel electrode 30 and the sub-pixel electrode 31 both acquire a display signal through the thin film transistor 7. Specifically, the thin film transistor 7 includes a gate electrode 72, a source electrode 70, and a drain electrode 71. The gate electrode 72 is connected to a gate line 50, the source electrode 70 is connected to a data line 51, and the drain electrode 71 is connected to the main pixel electrode 30 and the sub-pixel electrode 31.

The main pixel electrode 30 and the sub-pixel electrode 31 are arranged in parallel. The main pixel electrode 30 and the sub-pixel electrode 31 both include a main electrode line and a branch electrode line connected to the main electrode line, and the main electrode line of the main pixel electrode 30 is connected to the main electrode line of the sub-pixel electrode 31. Specifically, a vertical branch electrode line 300 and a lateral branch electrode line 301 that divide the main pixel electrode into four domains are included in the main pixel electrode 30, and the vertical branch electrode line 300 and the lateral branch electrode line 301 are substantially arranged in a “ [symbol] ” shape, and a plurality of parallel branch electrode lines 302 are respectively disposed in each of the domains, each of the branch electrode lines 302 in each of the domains is at least substantially connected to one of the vertical main electrode line 300 and the lateral main electrode line 301; similarly, the sub-pixel electrode 31 also includes a vertical main electrode line 310 and a lateral main electrode line 311, the vertical main electrode line 310 and the lateral main electrode line 311 divide the sub-pixel electrode 31 into four domains, and a plurality of branch electrode lines 312 are disposed in each of the domains. Here, the vertical main electrode line 300 of the main pixel electrode 30 is connected to the vertical main electrode line 310 in the sub-pixel electrode 31.

In FIG. 3, the main pixel electrode 30 has a “ [symbol] ” shape pattern as a whole, and the sub-pixel electrode 31 also has a “ [symbol] ” shape pattern. It can be understood that, in other examples, the sub-pixel electrodes 31 are arranged in other shapes, for example, in a planar or a comb shape.

In the disclosure, it is necessary to design a difference between the pattern of the main pixel electrode 30 and the pattern of the sub-pixel electrode 31.

Specifically, a ratio of a line width to a line spacing (Line/Space, L/S) of a branch electrode line 31 in the sub-pixel electrode is set to be different from a ratio of a line width to a line spacing of a branch electrode line in the main pixel electrode 30. In the figure, the ratio of the line width to the line spacing of the branch electrode line in the sub-pixel electrode 31 is less than the ratio of the line width to the line spacing of the branch electrode line in the main pixel electrode 30.

It will be understood that, in this embodiment, by setting the ratio of the line width to the line spacing of the branch electrode line in the sub-pixel electrode 31 less than the ratio of the line width to the line spacing of the branch electrode line in the main pixel electrode 30, when the thin film transistor 53 drives the pixel electrode, the potential difference between the main pixel electrode 30 and the common electrode 6 is different from the potential difference between the sub-pixel electrode 31 and the common electrode 6; specifically, in this example, since the ratio of the line width to the line spacing of the branch electrode line in the sub-pixel electrode 31 is less than the ratio of the line width to the line spacing of the branch electrode line in the main pixel electrode 30, it can be understood that, the smaller the line width of the electrode line is or the larger the line spacing is, the smaller the potential difference between the sub-pixel electrode 31 and the common electrode 6 is, and simultaneously, the smaller the electric field intensity corresponding to the region is, so that the deflection angle of the liquid crystal corresponding to the sub-pixel electrode is smaller than the deflection angle of the liquid crystal corresponding to the pixel electrode. When the deflection angle of the liquid crystal is small, the brightness becomes stronger at a large viewing angle, so that the above difference can make the liquid crystal display panel obtain a larger viewing angle. Simultaneously, since only a thin film transistor and a gate line are required for each pixel unit, the liquid crystal of the main pixel electrode and sub-pixel electrode can be driven, so as to obtain different deflection angles, thereby making the driving circuit simpler and improving the aperture ratio of the pixel.

It can be understood that in other embodiments, the ratio of the line width to the line spacing of the branch electrode line of the sub-pixel electrode 31 can also be set to be larger than the ratio of the line width to the line spacing of the branch electrode line of the main pixel electrode 30; based on the principle described in the previous paragraph, the purpose of increasing the viewing angle of the liquid crystal display panel can also be achieved.

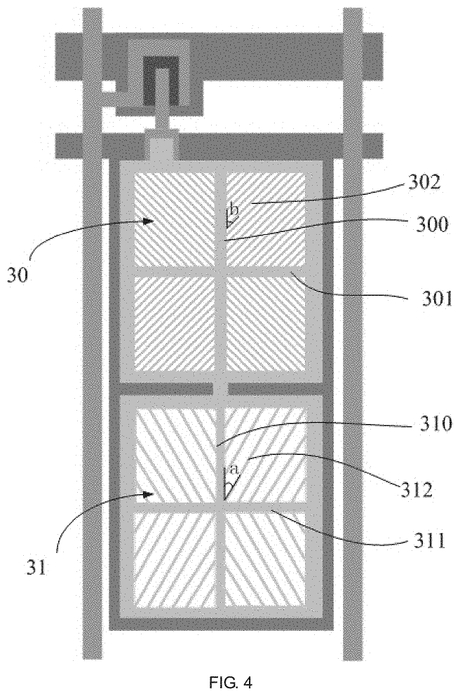

Further, it is necessary to design the pattern of the main pixel electrode and the pattern of the sub-pixel electrode to be different from each other. Please refer to FIG. 4, which shows a schematic structural view of another pixel unit in a liquid crystal display panel according to the disclosure.

In the embodiment shown in FIG. 4, the included angle between the branch electrode line of the sub-pixel electrode and the main electrode line of the sub-pixel electrode is set to be different from the included angle between the branch electrode line of the main pixel electrode and the main electrode line in the same direction of the main pixel electrode.

Specifically, in the FIG. 4, the included angle (denoted as b in the figure) between the branch electrode line 302 in the main electrode 30 and the vertical main electrode line 300 in the main electrode is greater than or equal to 45°, and the included angle (denoted as a in the figure) between the branch electrode line 312 in the sub-pixel electrode 31 and the vertical main electrode line 310 in the sub-pixel electrode 31 is less than 45°. Generally, the angle can be referred to as the tilt angle, it can be understood that in the sub-pixel electrode, decreasing the tilt angle can reduce the azimuth angle of the liquid crystal corresponding to the sub-pixel electrode, thereby improving the viewing angle of the liquid crystal display panel.

Also, it can be understood that, in other embodiments, the tilt angle of the branch electrode line in the main pixel may also be set to be less than 45° and the tilt angle of the branch electrode line in the sub-pixel may be set to be less than or equal to 45°; similarly, in other embodiments, the tilt angle of the branch electrode line in the main pixel and the tilt angle of the branch electrode line in the sub-pixel may be set to be the same, for example, both may be set to 45°.

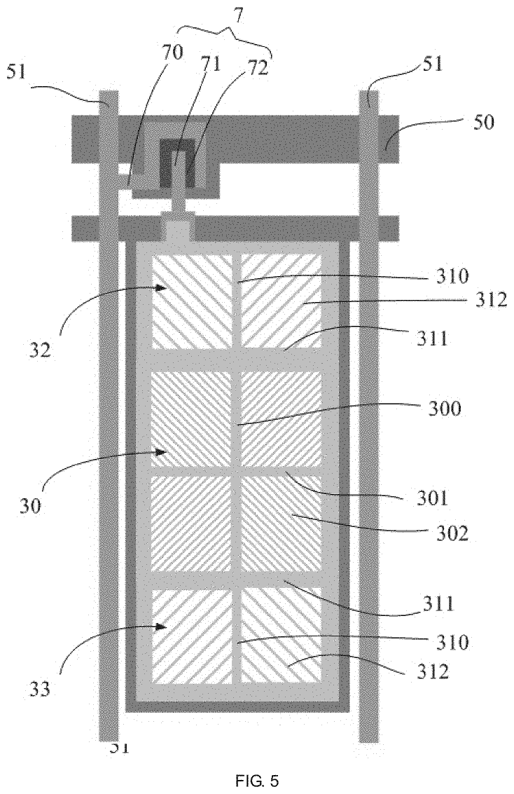

Please refer to FIG. 5, which shows a structural schematic view of still another embodiment of a pixel electrode. In this embodiment, the difference from the structure shown in FIG. 3 is that in this embodiment, the main pixel electrode 30 and the sub-pixel electrode are alternately arranged with each other; the sub-pixel electrode further includes a first sub-pixel electrode 32 and a second sub-pixel electrode 33. Each of the first sub-pixel electrode 32 and the second sub-pixel electrode 33 includes two domains. The main pixel electrode 30 further includes four domains, and the main pixel electrode 30 is disposed between the first sub-pixel electrode 32 and the second sub-pixel electrode 33. Specifically, a vertical main electrode line 300 and a lateral main electrode line 301 that divide the main pixel electrode into four domains are included in the main pixel electrode 30, and a plurality of parallel branch electrode lines 302 are disposed in each of the domains respectively. The first sub-pixel electrode 32 and the second sub-pixel electrode 33 respectively include a vertical main electrode line 310 and a lateral main electrode line 311, and a plurality of branch electrode lines 312 are disposed in each of the domains. The vertical branch electrode lines 300 of the main pixel electrodes 30 are respectively connected to the vertical branch electrode lines 310 of the first sub-pixel electrode 32 and the second sub-pixel electrode 33. The other structures of this embodiment are the same as those shown in FIG. 3, which are not described herein again.

It can be understood that, for the structure in FIG. 4, the included angle between the branch electrode line 302 and the vertical main electrode line 300 in the main pixel electrode 30 can also be the same or different as the included angle between the branch electrode 312 and vertical main electrode line 310 in the first sub-pixel electrode 32 (or the second sub-pixel electrode 33).

Please refer to FIG. 5, which shows a schematic structural view of further another embodiment of a pixel electrode. In this embodiment, the difference from the structure shown in FIG. 3 is that in the embodiment, the main pixel electrode 30 and the sub-pixel electrode 31 are nested inside each other, and the sub-pixel electrode 31 is disposed at a center of the main pixel electrode 30.

Specifically, the main pixel electrode 30 and the sub-pixel electrode 31 both include a main electrode line and a branch electrode line connected to the main electrode line, and the main electrode line of the main pixel electrode 30 is connected to the main electrode line of the sub-pixel electrode 31. Specifically, the sub-pixel electrode 31 also includes a vertical branch electrode line 310 and a lateral branch electrode line 311, and the vertical branch electrode line 310 and the lateral branch electrode line 311 divide the sub-pixel electrode 31 into four domains, and a plurality of branch electrode lines 312 are disposed in each of the domains. In the main pixel electrode 30, the vertical main electrode line 300, the lateral main electrode line 301 and the frame electrode line 303 surrounding the sub-pixel electrode 31 form a main electrode line, and the main pixel electrode is divided into four domains by main electrode line, a plurality of parallel branch electrode lines 302 are disposed in each of the domains respectively, each of the branch electrode lines 302 in each of the domains is connected to at least one of the vertical branch electrode line 300, the lateral main electrode 302 or the frame electrode line 303; Similarly, the vertical main electrode line 300 of the main pixel electrode 30 is connected to the vertical main electrode line 310 in the sub-pixel electrode 31. The other structures of this embodiment are the same as those shown in FIG. 3, which are not described herein again.

It can be understood that, for the structure of FIG. 5, the included angle between the branch electrode line 302 and the vertical main electrode line 300 in the main pixel electrode 30 is set to be the same or different from the included angle between the branch electrode line 312 and the vertical main electrode line 310 in the sub-pixel electrode 31.

The implementation of the embodiment of the disclosure has the following advantageous effects:

In this embodiment of the disclosure, the pixel electrode in each pixel unit is divided into the main pixel electrode and the sub-pixel electrode, and by setting the pattern of the main pixel electrode and the pattern of the sub-pixel electrode to be different, for example, the ratio of the line width to the line spacing of the branch electrode line in the sub-pixel electrode is set to be different from the ratio of the line width to the line spacing of the branch electrode line in the main pixel electrode, or a included angle between the branch electrode line of the sub-pixel electrode and the main electrode line of the sub-pixel electrode is set to be different from a included angle between the branch electrode line of the main pixel electrode and the main electrode line in the same direction of the main pixel electrode; so when the thin film transistor drives the pixel electrode, the potential difference between the main pixel electrode and the common electrode is different from the potential difference between the sub-pixel electrode and the common electrode; the above difference can make the deflection angle of the liquid crystal corresponding to one of the regions smaller than the deflection angle of the liquid crystal corresponding to the other region, so as to obtain a larger viewing angle of the liquid crystal display panel.

In the embodiment of the disclosure, the included angle between the branch electrode line and the vertical main electrode line in the sub-pixel electrode is set to be different from the angle between the branch electrode line and the vertical main electrode line in the main pixel electrode, the azimuth angles of the liquid crystals corresponding to the partial pixel electrodes can be reduced, so that the viewing angle of the liquid crystal display panel can be improved;

simultaneously, in the embodiment of the disclosure, since only a thin film transistor and a gate line are needed to be used for each pixel unit, the driving circuit is simplified, and the aperture ratio of the pixel is increased.

It is to be noted that, in the context, relational terms such as first and second are used only to distinguish an entity or an operation from another entity or another operation without necessarily requiring or implying that such entities or operations have any such actual relationship or sequence. Moreover, terms “include”, “include” or any other variant thereof is intended to encompass a non-exclusive inclusion such that processes, methods, articles, or devices that include a series of elements include not only those elements but also those that are not explicitly listed. In the absence of more restrictions, the elements defined by the statement “including a . . . ” do not preclude the presence of additional elements in the process, method, article, or device that includes the elements.

It should be indicated that the present application can also be improved and modified by those skilled in the art without departing from the principle of the present application, and these improvements and modifications also fall within the protection scope of the claims of the present application.

What is claimed is:

1. A liquid crystal display panel having a novel pixel design, comprising:
a first substrate;
a second substrate disposed opposite to the first substrate; and
a liquid crystal layer disposed between the first substrate and the second substrate;
wherein a common electrode is arranged on a side surface of the first substrate;
wherein a plurality of gate lines and a plurality of data lines are disposed on the second substrate, wherein the plurality of gate lines and the plurality of data lines define a plurality of pixel units, each of the plurality of pixel units comprises a main pixel electrode and a sub-pixel electrode connected to each other, and a pattern of the main pixel electrode is different from a pattern of the sub-pixel electrode; each of the plurality of pixel units further comprises a thin film transistor connected to one of the plurality of gate lines, and the main pixel electrode and the sub-pixel electrode both acquire a display signal through the thin film transistor.

2. The liquid crystal display panel as claimed in claim 1, wherein the main pixel electrode and the sub-pixel electrode both comprise a main electrode line and a branch electrode line connected to the main electrode line, and the main electrode line of the main pixel electrode is connected to the main electrode line of the sub-pixel electrode.

3. The liquid crystal display panel as claimed in claim 2, wherein a ratio of a line width to a line spacing of the branch electrode line in the sub-pixel electrode is different from a ratio of a line width to a line spacing of the branch electrode line in the main pixel electrode.

4. The liquid crystal display panel as claimed in claim 3, wherein the main pixel electrode and the sub-pixel electrode are arranged in parallel, and the ratio of the line width to the line spacing of the branch electrode line in the sub-pixel electrode is less than the ratio of the line width to the line spacing of the branch electrode line in the main pixel electrode.

5. The liquid crystal display panel as claimed in claim 3, wherein the main pixel electrode and the sub-pixel electrode are alternately arranged with each other; wherein the sub-pixel electrode comprises a first sub-pixel electrode and a second sub-pixel electrode, and the main pixel electrode is disposed between the first sub-pixel electrode and the second sub-pixel electrode.

6. The liquid crystal display panel according to claim 2, wherein the main pixel electrode and the sub-pixel electrode are nested inside each other, and the sub-pixel electrode is disposed at a center of the main pixel electrode.

7. The liquid crystal display panel as claimed in claim 2, wherein an included angle between the branch electrode line of the sub-pixel electrode and the main electrode line of the sub-pixel electrode is different from an included angle between the branch electrode line of the main pixel electrode and the main electrode line in the same direction of the main pixel electrode.

8. The liquid crystal display panel as claimed in claim 7, wherein an included angle between the branch electrode line in the main pixel electrode and a vertical main electrode line in the main pixel electrode is greater than or equal to 45°, an included angle between the branch electrode line in the sub-pixel electrode and a vertical main electrode line in the sub-pixel electrode is less than 45°.

9. The liquid crystal display panel as claimed in claim 1, wherein the main pixel electrode is a “ [symbol] ” shape pattern and the sub-pixel electrodes are planar or comb-shaped.

10. The liquid crystal display panel as claimed in claim 2, wherein the plurality of data lines arranged in a column direction and the plurality of gate lines arranged in a row direction are arranged on the second substrate, and two adjacent data lines and two adjacent gate lines jointly define the pixel unit; in the pixel unit, the thin film transistor comprises a gate electrode, a source electrode, and a drain electrode, the gate electrode is connected to one of the plurality of gate lines, the source electrode is connected to of the plurality of data lines, and the drain electrode is connected to the main pixel electrode and the sub-pixel electrode.

11. A liquid crystal display panel having a novel pixel design, comprising:
a first substrate;
a second substrate disposed opposite to the firsts substrate; and
a liquid crystal layer disposed between the first substrate and the second substrate;
wherein a common electrode is arranged on a side surface of the first substrate;
wherein a plurality of gate lines and a plurality of data lines are disposed on the second substrate, wherein the plurality of gate lines and the plurality of data lines define a plurality of pixel units, each of the plurality of pixel units comprises a main pixel electrode and a sub-pixel electrode connected to each other, and a pattern of the main pixel electrode is different from a pattern of the sub-pixel electrode; each of the plurality of pixel units further comprises a thin film transistor connected to one of the plurality of gate lines, and the main pixel electrode and the sub-pixel electrode both acquire a display signal through the thin film transistor;
wherein the main pixel electrode and the sub-pixel electrode both comprise a main electrode line and a branch electrode line connected to the main electrode line, and the main electrode line of the main pixel electrode is connected to the main electrode line of the sub-pixel electrode;
wherein an included angle between the branch electrode line of the sub-pixel electrode and the main electrode line of the sub-pixel electrode is different from an included angle between the branch electrode line of the main pixel electrode and the main electrode line in the same direction of the main pixel electrode.

12. The liquid crystal display panel as claimed in claim 11, a ratio of a line width to a line spacing of a branch electrode line in the sub-pixel electrode is different from a ratio of a line width to a line spacing of a branch electrode line of the main pixel electrode.

13. The liquid crystal display panel as claimed in claim 12, the main pixel electrode and the sub-pixel electrode are arranged in parallel, and the ratio of the line width to the line spacing of the branch electrode line in the sub-pixel electrode is less than the ratio of the line width to the line spacing of the branch electrode line in the main pixel electrode.

14. The liquid crystal display panel as claimed in claim 13, wherein the main pixel electrode and the sub-pixel electrode are alternately arranged with each other; wherein the sub-pixel electrode comprises a first sub-pixel electrode and a second sub-pixel electrode, and the main pixel electrode is disposed between the first sub-pixel electrode and the second sub-pixel electrode.

15. The liquid crystal display panel as claimed in claim 14, wherein the main pixel electrode and the sub-pixel electrode are nested inside each other, and the sub-pixel electrode is disposed at a center of the main pixel electrode.

16. The liquid crystal display panel as claimed in claim 14, an included angle between the branch electrode line of the sub-pixel electrode and the main electrode line of the sub-pixel electrode is different from an included angle between the branch electrode line of the main pixel electrode and the main electrode line in the same direction of the main pixel electrode.

17. The liquid crystal display panel as claimed in claim 11, wherein an included angle between the branch electrode line of the main pixel electrode and a vertical branch electrode line in the main pixel electrode is greater than or equal to 45°, and an included angle between the branch electrode line in the sub-pixel electrode and a vertical main electrode line in the sub-pixel electrode is less than 45°.

18. The liquid crystal display panel as claimed in claim 11, wherein the main pixel electrode is a “ [symbol] ” shape pattern and the sub-pixel electrodes are planar or comb-shaped.

19. The liquid crystal display panel as claimed in claim 12, wherein the plurality of data lines arranged in a column direction and a plurality of gate lines arranged in a row direction are arranged on the second substrate, and two adjacent data lines and two adjacent gate lines jointly define the pixel unit; in the pixel unit, the thin film transistor comprises a gate electrode, a source electrode, and a drain electrode, the gate electrode is connected to one of the plurality of gate lines, the source electrode is connected to one of the plurality of data lines, and the drain electrode is connected to the main pixel electrode and the sub-pixel electrode.
